(19) United States
(12) Patent Application Publication
(10) Pub. No.: US 2007/0125814 A1
(43) Pub. Date: Jun. 7, 2007

(54) Universal carrying device

(76) Inventor: Warren Edward Roh, Littleton, CO (US)

Correspondence Address: LAW OFFICE OF DALE B. HALLING, LLC, 655 SOUTHPOINTE CT, SUITE 100, COLORADO SPRINGS, CO, 80906, US

(21) Appl. No.: 10/575,005

(22) PCT Filed: Oct. 7, 2004
(86) PCT No.: PCT/US04/33110

§ 371 Date: Apr. 6, 2006

Related U.S. Application Data
(60) Provisional application No. 60/510,075, filed on Oct. 9, 2003.

(51) Int. Cl. B44D 3/14; A45C 1/04; A45F 3/16

(52) U.S. Cl. 224/148.7; 224/666; 224/678

(57) ABSTRACT

A universal carrying device (50) has a first substantially rectangular cover (54). A substantially rectangular carrier (56) has an opening (54). A hinge (52) attaches the first substantially rectangular cover to the first substantially rectangular carrier.

### RELATED APPLICATIONS

The present invention claims priority on provisional patent application, Ser. No. 60/510,075, filed on Oct. 9, 2003, entitled “Universal Card”.

### FIELD OF INVENTION

The present invention relates generally to carrying devices and more particularly to a universal carrying device.

### BACKGROUND OF THE INVENTION

People often want to be able to carry a drink, tools, and other carriable objects around while they are on the move. Devices for this application have include fanny packs that have bottle holsters, plastic carriers that slide behind a belt or into the top of the pants, tool holster, tool belts and even backpacks having a bladder to hold liquid. People use these while working, exercising and walking. Unfortunately, some of these devices are expensive and bulky, others have limited utility. Thus there exists a need for a universal carrier that overcomes these and other problems.

### SUMMARY OF INVENTION

A universal carrying device that overcomes these and other problems has a first substantially rectangular cover. A substantially rectangular carrier has an opening. A hinge attaches the first substantially rectangular cover to the first substantially rectangular carrier. The hinge may be a living hinge. The substantially rectangular carrier may have a hinge line. The hinge line may extend across the opening. The opening may have a narrow end and a fat end, the fat end is near the hinge. The first substantially rectangular cover may snap fit with the substantially rectangular carrier. A lip may extend along a portion of the substantially rectangular cover.

In one embodiment, a universal carrying device has a first substantially planar cover. A second substantially planar cover has an opening. A hinge attaches the first substantially planar cover and the second substantially planar cover. The second substantially planar cover may have a hinge line. The first substantially planar cover may have a lip. The first substantially planar cover and the second substantially planar cover may snap fit together. The opening may have a wide end and a narrow end. The first substantially planar cover may have a flange along a portion of the lip. The hinge may be a living hinge.

In one embodiment, a universal carrying device has a first substantially planar cover with a lip along a portion of a periphery of the first substantially planar cover. A second substantially planar cover has an opening. A living hinge attaches the first substantially planar cover and the second substantially planar cover. A second living hinge may be included in the second substantially planar cover. The first substantially planar cover may snap fit into the second substantially planar cover. The first substantially planar cover may have a printing or embossing surface. A carrier adapter may engage an opening of the second substantially planar cover.

### BRIEF DESCRIPTION OF THE DRAWINGS

FIG. 1A is a front view of a universal carrier in a folded position in accordance with one embodiment of the invention;

FIG. 1B is a open view of the universal carrier of FIG. 1A in accordance with one embodiment of the invention;

FIG. 2 is side view of a universal carrier in an unfolded position in accordance with one embodiment of the invention;

FIG. 3 is an end view of the universal carrier in an unfolded position in accordance with one embodiment of the invention;

FIG. 4 is a back view of a universal carrier in a folded position in accordance with one embodiment of the invention;

FIG. 5 is a side view of a universal carrier in a folded position in accordance with one embodiment of the invention;

FIG. 6 is a front view of a universal carrier in a folded position in accordance with one embodiment of the invention;

FIG. 7 is an exterior view of a universal carrier in an unfolded position in accordance with one embodiment of the invention;

FIG. 8 is side view of a universal carrier in an unfolded position in accordance with one embodiment of the invention;

FIG. 9 is an interior view of a universal carrier in an unfolded position in accordance with one embodiment of the invention;

FIG. 10 is a partial view of a universal carrier in a folded position in accordance with one embodiment of the invention;

FIG. 11 is a cross sectional view of an end of a universal carrier in a folded position in accordance with one embodiment of the invention;

FIG. 12 is a cross sectional view of an end of a universal carrier in a folded position in accordance with one embodiment of the invention;

FIG. 13 is a side view of a carrier adapter in accordance with one embodiment of the invention;

FIG. 14 is a side view of a carrier adapter in accordance with one embodiment of the invention;

FIG. 15 is a side view of a carrier adapter attached to a band in accordance with one embodiment of the invention;

FIG. 16 is an interior view of a universal carrier with a carrier adapter engaging the universal carrier in accordance with one embodiment of the invention;

FIG. 17 is an interior view of a universal carrier with a carrier adapter engaging the universal carrier in accordance with one embodiment of the invention;

FIG. 18A is side view of a carrier adapter in accordance with one embodiment of the invention;

FIG. 18B is an interior view of a universal carrier with a carrier adapter engaging the universal carrier in accordance with one embodiment of the invention;

FIG. 19 is a side view of the universal carrier engaging a belt in accordance with one embodiment of the invention;

FIG. 20 is a view of the carrier adapter on a beverage can and engaging a universal carrier in accordance with one embodiment of the invention;

FIG. 21 is a view of the carrier adapter on a beverage can and engaging a universal carrier in accordance with one embodiment of the invention;

FIG. 22 is an enlarged view of the carrier adapter on a beverage can in FIG. 21 and engaging a universal carrier in accordance with one embodiment of the invention;

FIG. 23 illustrates the universal carrier holding a beverage can in accordance with one embodiment of the invention′ FIG. 24 illustrates the universal carrier on belt of a user in accordance with one embodiment of the invention;

FIG. 25 illustrates the universal carrier and a bottle shaped container in accordance with one embodiment of the invention;

FIG. 26 illustrates the universal carrier attached to a bottle shaped container in accordance with one embodiment of the invention;

FIG. 27 is a close up view of the universal carrier attached to a bottle shaped container in accordance with one embodiment of the invention;

FIG. 28 illustrates the universal carrier and a bottle shaped container in accordance with one embodiment of the invention;;

FIG. 29 is a back view of a universal carrier in a folded position in accordance with one embodiment of the invention;

FIG. 30 is a side view of a universal carrier in a folded position in accordance with one embodiment of the invention;

FIG. 31 is a front view of a universal carrier in a folded position in accordance with one embodiment of the invention;

FIG. 32 is an unfolded interior view of a universal carrier in a folded position in accordance with one embodiment of the invention;

FIG. 33 provides an illustration of a side view of FIG. 32;

FIG. 34 provides an illustration of a bottom view of FIG. 32;

FIG. 35 provides a perspective illustration of an alternative embodiment closed and latched for storage or presentation as a card;

FIG. 36 provides a perspective illustration of FIG. 35 opened for use as a gadget carrier;

FIG. 37 provides a perspective illustration of an alternative embodiment closed for storage or presentation as a card;

FIG. 38 provides a perspective illustration of FIG. 37 opened for use as a gadget carrier;

FIG. 39 provides an illustration of a perspective view of FIG. 38 holding a hammer with an adapter;

FIG. 40 provides an illustration of a perspective view of a universal card that provides for insertion, storage, and removal of a separate credit card or other object;

FIG. 41 provides an illustration of an exploded perspective view of FIG. 40;

FIG. 42 provides an illustration of a top view of FIG. 41 with the stored card partially extended;

FIG. 43 provides an illustration of a bottom view FIG. 41;

FIG. 44 provides an illustration of a top view of an alternative embodiment utilizing an end slot for credit or hotel room key card insertion, storage, and removal;

FIG. 45 provides a bottom view of FIG. 44;

FIG. 46 provides a perspective illustration of an alternative embodiment where the display portion is also a container to hold a single or plurality of cards or objects; and

FIG. 47 provides a perspective illustration of FIG. 46 with the display and card container portion and gadget carrier portion opened for use as a gadget carrier.

### DETAILED DESCRIPTION OF THE DRAWINGS

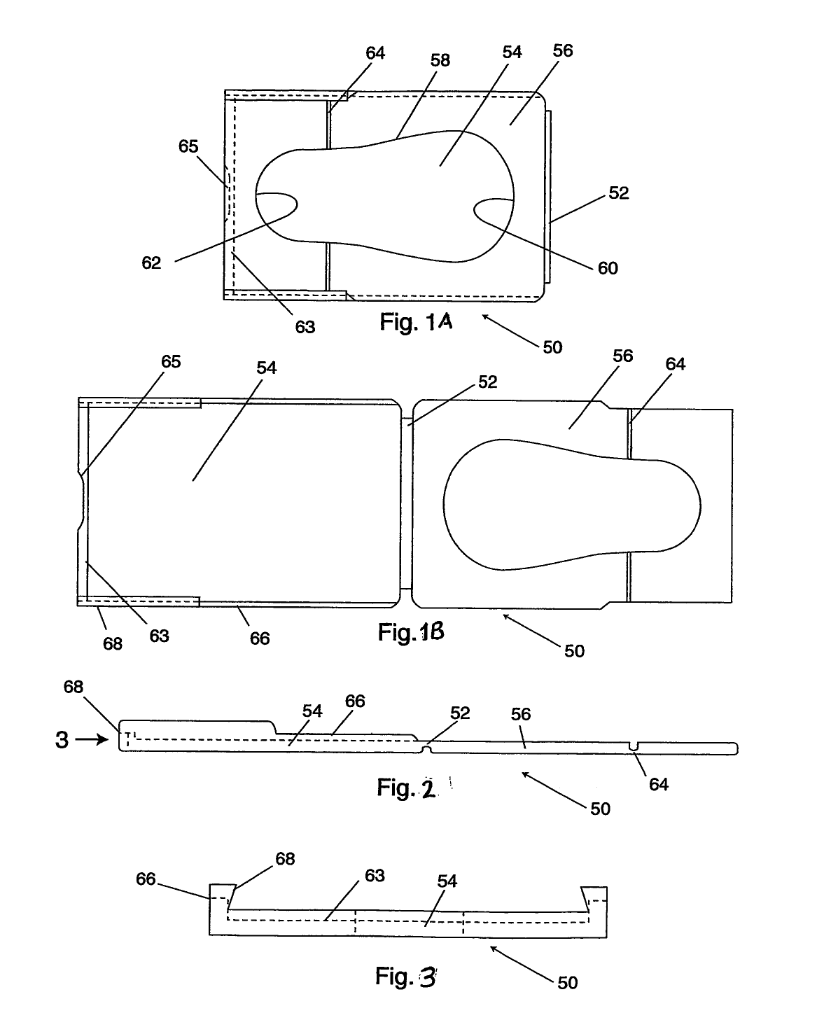

FIG. 1A is a front view of a universal carrier 50 in a folded position in accordance with one embodiment of the invention. FIG. 1B is a open view of the universal carrier of FIG. 1A in accordance with one embodiment of the invention. The universal carrier 50 has a living hinge 52 that connects a first substantially planar cover 54 with a second substantially planar carrier 56. The substantially rectangular carrier 56 has an opening having a light bulb type shape. A wide end 60 of the opening 58 is near the living hinge 52 and a narrow end 62 is opposite the wide end 60. The second substantially planar surface 56 has a second hinge 64 that extends across the opening 58. A cover ridge 63 acts as a stop when a card is inserted into the carrier 50. A finger access slot 65 is next to the cover ridge 63. The finger access slot 65 is used to unsnap the cover 54 when it is held by the flange 68 (see FIG. 3)

FIG. 2 is side view of a universal carrier 50 in an unfolded position in accordance with one embodiment of the invention. The figure illustrates the second hinge 64 in the second cover 56 as a living hinge although other types of hinges can be used for both hinges. A living hinge is a thin line of plastic that is flexible enough to be easily bent but strong enough to withstand repeated openings and closings. The second cover 56 is coupled to the first cover 54 by the living hinge 52. The first cover 54 has a lip or ledge 66 along a portion of the periphery of the first cover 54. This provides a space between the covers 54 & 56 when the universal carrier is in a folded position. A flange 68 extends along a portion of the lip 66.

FIG. 3 is an end view of the universal carrier 50 in an unfolded position in accordance with one embodiment of the invention. This figure illustrates the flange 68 on the first cover 54. The flange 68 has two functions. One function is that the flange 68 provides a snap fit with the second cover 56. The second function is that the flange holds a business card, credit card, driver's license, etc.

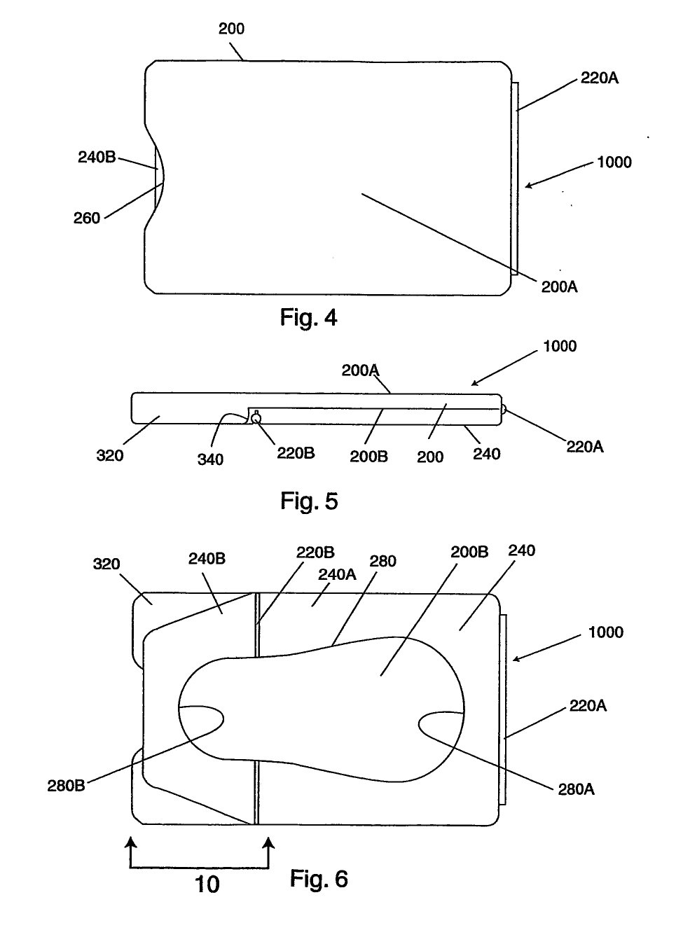

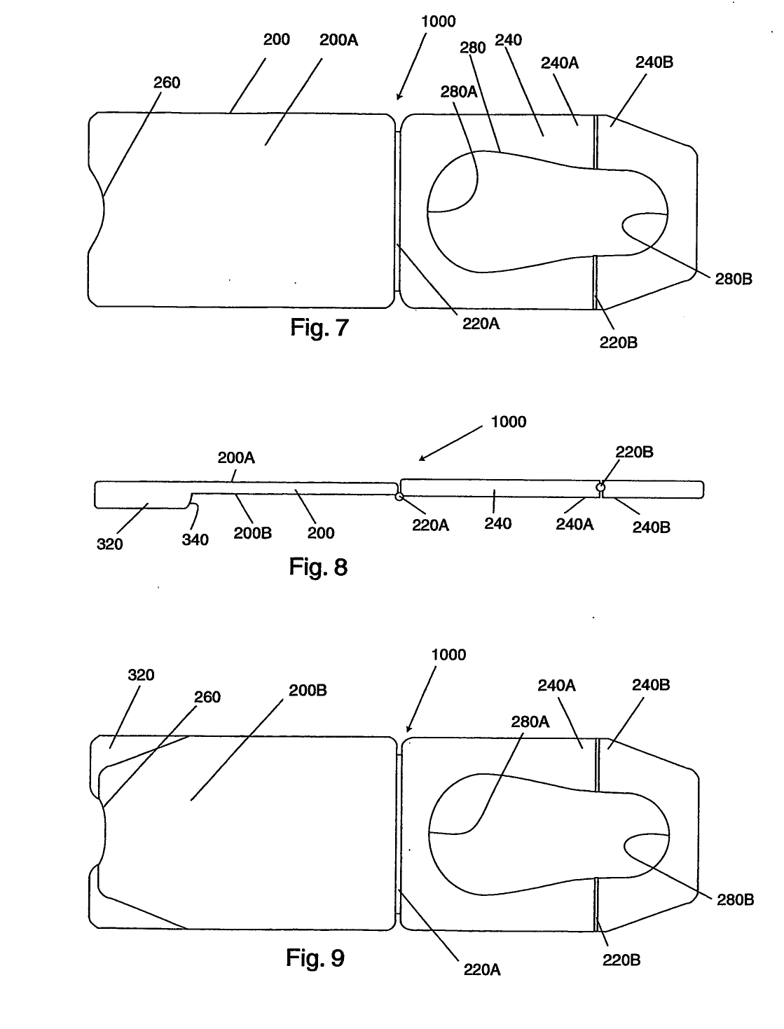

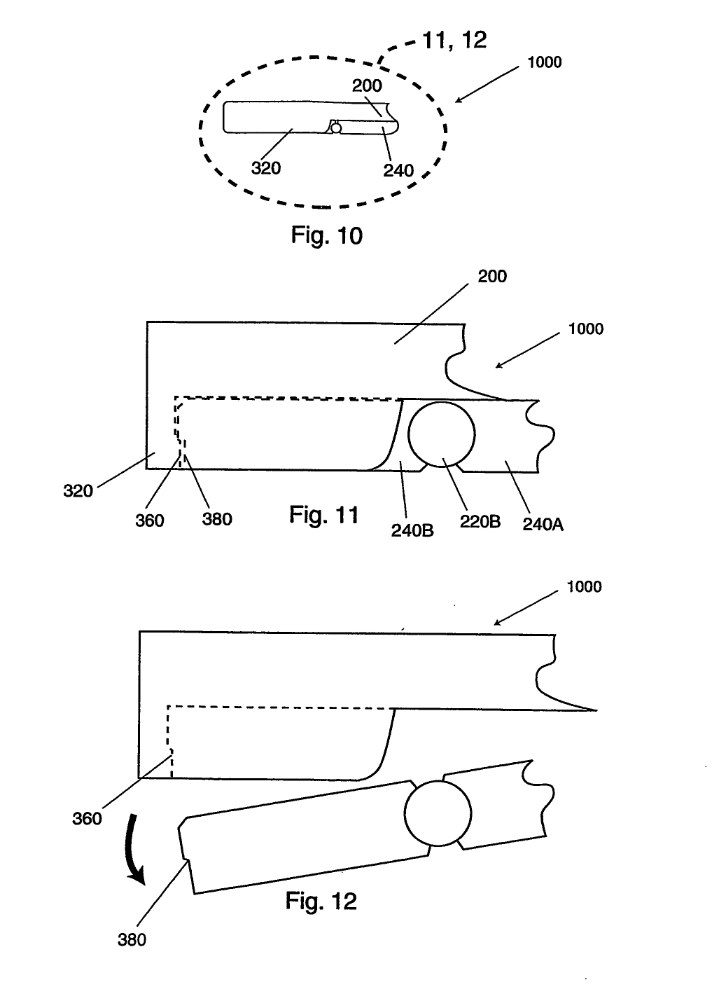

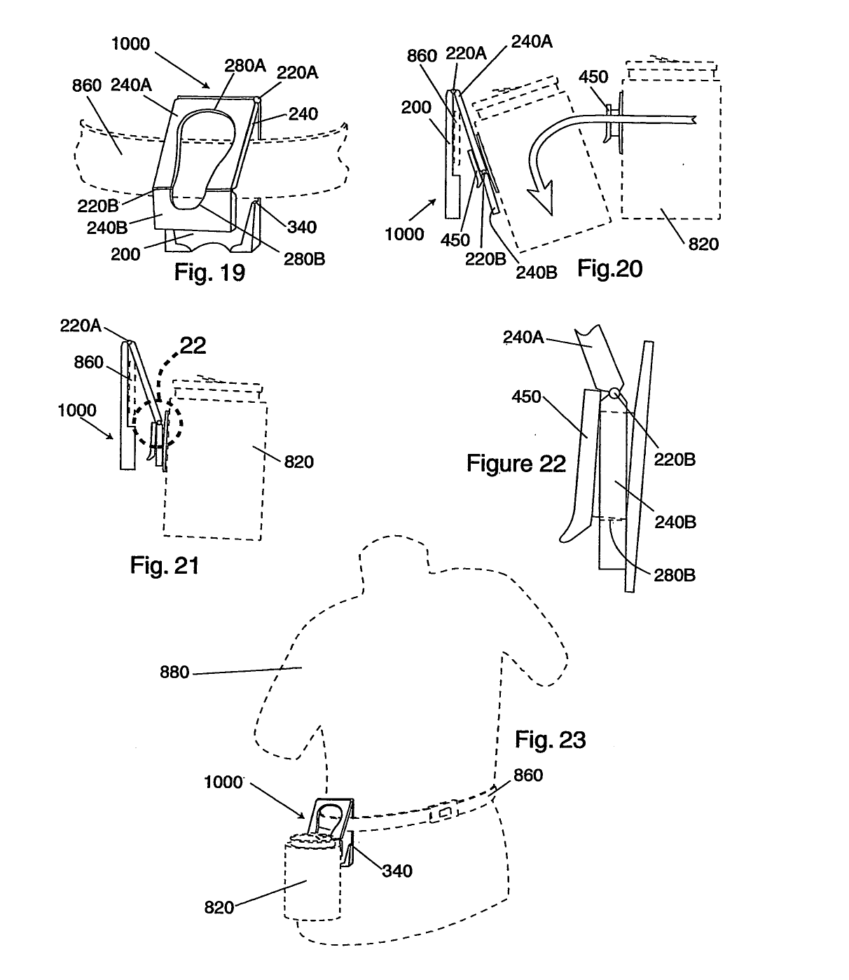

FIGS. 4, 5, and 6 illustrate a universal card and gadget carrier invention 1000 in its folded business card configuration. FIGS. 7, 8, and, 9 illustrate invention 1000 with its information and display portion and its gadget carrier portion opened 180 degrees. FIG. 10 illustrates a side view of the latching area of FIG. 9. FIGS. 11 and 12 illustrate an enlargement of FIG. 10 illustrating one form of an interference fit latch 320 and its operation. In FIGS. 4-9, universal card illustration.and display portion 200 has two usable sides with which to display information, front side 200A and back side 200B (see FIG. 5). FIG. 4 illustrates what universal card and gadget carrier 1000 looks like in a closed configuration as it would be presented as a card only. FIG. 5 illustrates a side view of FIG. 4 and FIG. 6 illustrates the reverse or bottom view of FIG. 4. FIG. 8 illustrates that gadget carrier portion 240 consists of a two hinged portion—240A connected by hinge 220A to information and display portion 200 and by hinge 220B that serves to hingedly join 240A to 240B. In FIGS. 7 and 9 it can be seen how hinge 220B separates the wide opening 280A of portion 240A from the distal, narrow opening 280B of portion 240B. FIG. 10 illustrates how latch 320, which is integral to display portion 200, acts to captivate gadget carrier portion 240 when universal card 1000 is closed. FIG. 11 illustrates how latch 320 captivates gadget carrier portion 240B by causing an interference fit, male protuberance 360 latching into female depression 380. Referring to FIG. 4, to open and separate display portion 200 from gadget carrier portion 240, the user grasps the two edges, the top and bottom edges of 1000 with one hand and separates the two portions by applying pressure through finger slot 260 against the carrier portion end 240B with a finger of the opposite hand. When unlatched, as illustrated in FIG. 12, the universal card is transformed into a functional gadget carrier. Although not shown as such in FIGS. 4-12, the male to female interference fit latch may extend around the entire inside edges of latch 320. In FIG. 5, the terminating edge 340 of latch 320 acts to reduce the possibility of display portion 200 being inadvertently dislodged from a waistband or strap. FIG. 19 illustrates how edge 340 can be positioned below belt or strap 860. When worn as a gadget carrier as illustrated in FIG. 23, it can be clearly seen how edge 340 would reduce the chance of the universal carrier from dislodging from behind belt 860 during the user's normal movement.

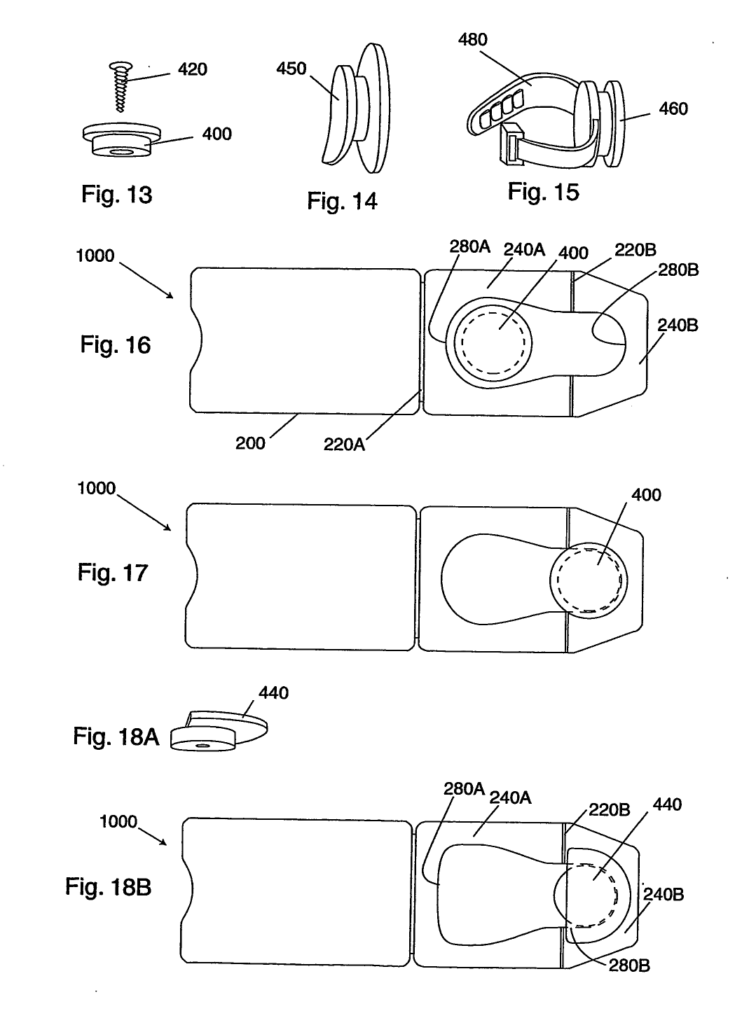

FIGS. 13-15, and 18A illustrate a variety of communicative gadget adapters that could be used on a variety of different gadgets allowing them to be carried by any embodiment of universal carrier 1000 herein. FIG. 13 illustrates an adapter 400 having two different diameter cylinders with a central bore to accept mechanical attachment fastener 420. As illustrated in FIG. 16, when adapter 400 is inserted into wide opening 280A, the larger outside diameter of adapter 400 is smaller than the inside diameter of wide opening 280A, providing for an easy insertion fit. In FIG. 17, adapter 400 is moved to narrow opening 280B, which is sized to closely accept the smaller diameter of adapter 400 which is hidden and shown as dashed, the larger diameter of adapter 400 can no longer be removed from 280B in the direction away from view. FIG. 14 adapter 450 illustrates another shaped adapter that will communicate with carrier portion 240A and 240B. FIG. 15, 460 offers another adapter alternative that can be attached to a gadget using strap or tie 480. FIG. 16 illustrates the relative difference between wide opening 280A and the larger diameter cylinder of adapter 400. Substantial clearance allows easy insertion for adapter 400's large diameter cylindrical portion into opening 280A. FIG. 17 illustrates that when adapter 400 is moved to narrow opening 280B the smaller diameter cylinder of adapter 400 presents a close tolerance fit to opening 280B. Therefore, adapter 400 is held captive. FIG. 18A, 440 offers yet another shape of adapter. FIG. 18B illustrates how when 440 is used with carrier portion 240A, hinge 220B, and 240B they communicate to provide a significant captivation due to the increased surface area baring on hinge 220A when the gadget is acted on by gravity. FIG. 18B also illustrates a different shaped slot 280A than previous figures depict; this illustrates that any form of a wide opening 280A and narrow opening 280B that communicates with an appropriately shaped adapter which could be a hook, strap, caribiner, t-bar, etc. is considered in this inventive aspect of carrier portion 240.

FIG. 19 illustrates a universal card 1000 configured as a gadget carrier and illustrates how display portion 200 is inserted behind belt or strap 860 while carrier portion 240 hangs over 860. In FIG. 19, it can be seen how hinge 220B separates 240A and 240B and the difference in angles will act to captivate a gadget or gadget adapted to be carried in opening 280B. FIGS. 20 through 23 illustrate how a gadget is carried and captivated by universal card 1000 when the gadget or adapted gadget inserts from the top side of 240 or in a relationship that is orthogonal to the force of gravity. FIG. 20 illustrates gadget 820, depicted as a soda can inserted into an insulating sleeve, being adapted by adapter 450 to fit into and be captivated by carrier portion 240B. As illustrated by the arrow in FIG. 20, the adapter is first moved into wide opening 280A from the top side followed by a downward motion into narrow opening 280B. Also illustrated in FIG. 20 is how the act of passing adapter 450 past hinge 220B aligns carrier portions 240A and 240B which allows adapter 450 easy passage from wide opening 280A to narrow opening 280B. FIG. 21 illustrates how when 820 is released, gravity causes it to align itself as illustrated thus creating an angular captive condition between adapter 450 and carrier portion 240. In FIG. 21 and its blowup area FIG. 22 the larger diameter cylindrical portion of adapter 450 is held within the lower edge of narrow slot 280B by the downward force exerted by 240A. In FIG. 22, adapter 450 cannot move past carrier hinge 280B unless 240A and lower 240B are axially aligned with one another, thus adapter 450 is captured against 240B as depicted. FIG. 23 illustrates how universal card 1000 appears when used as a belt supported carrier.

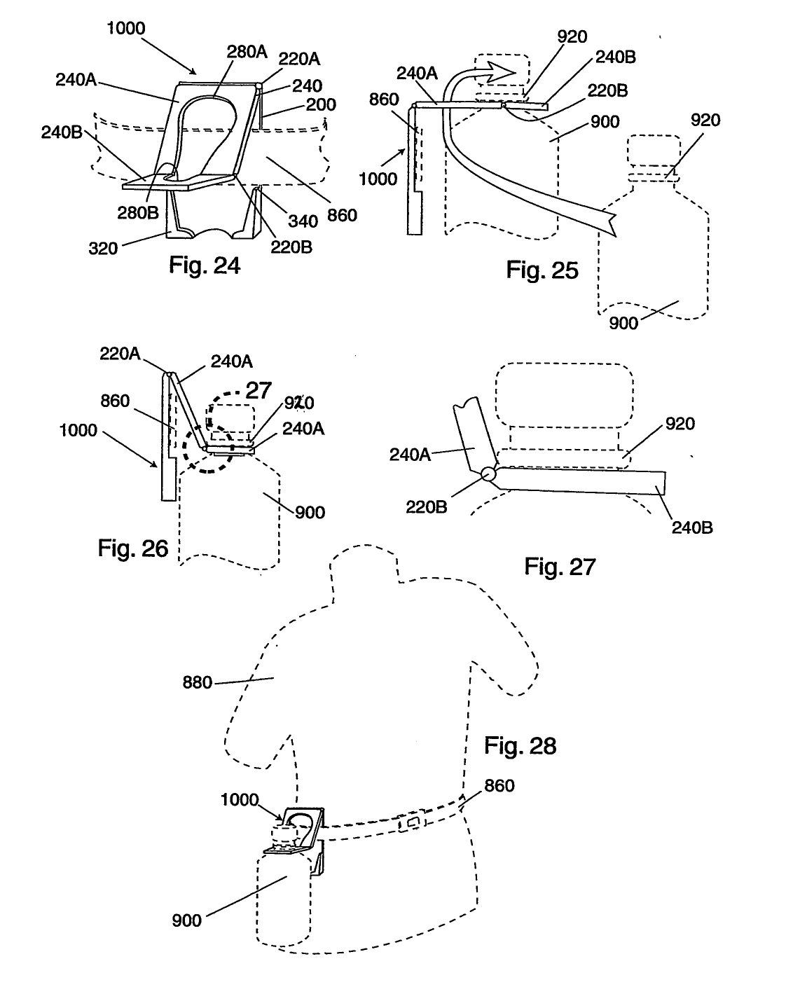

FIG. 24 again illustrates universal card 1000 configured as a gadget carrier and how display portion 200 can be inserted behind belt or strap 860 while carrier portion 240 hangs over 860. FIGS. 25 through 28 illustrate how a bottle 900 is carried and captivated by universal card 1000 when the adapted hammer inserts from the bottom of portion 240. FIG. 25 illustrates how the bottle 900 is inserted into the wide opening 280A from below followed by a sliding movement into narrow opening 280B. The lip 920 of the bottle 900 is wider than the narrow opening 280B. Also illustrated in FIG. 25 is how the act of passing the bottle 900 neck past hinge 220B aligns carrier portions 240A and 240B to allow adapter 400 easy passage. FIG. 26 illustrates how the bottle 900 when released, gravity causes it to align itself as illustrated, thus creating an angular captive condition between lip 920 and carrier portion 240A. FIG. 27 shows that bottle lip 920 cannot move past hinge 220B to carrier portion 240A unless 240A and 240B are axially realigned with one another allowing the lip 920 of the bottle to pass.

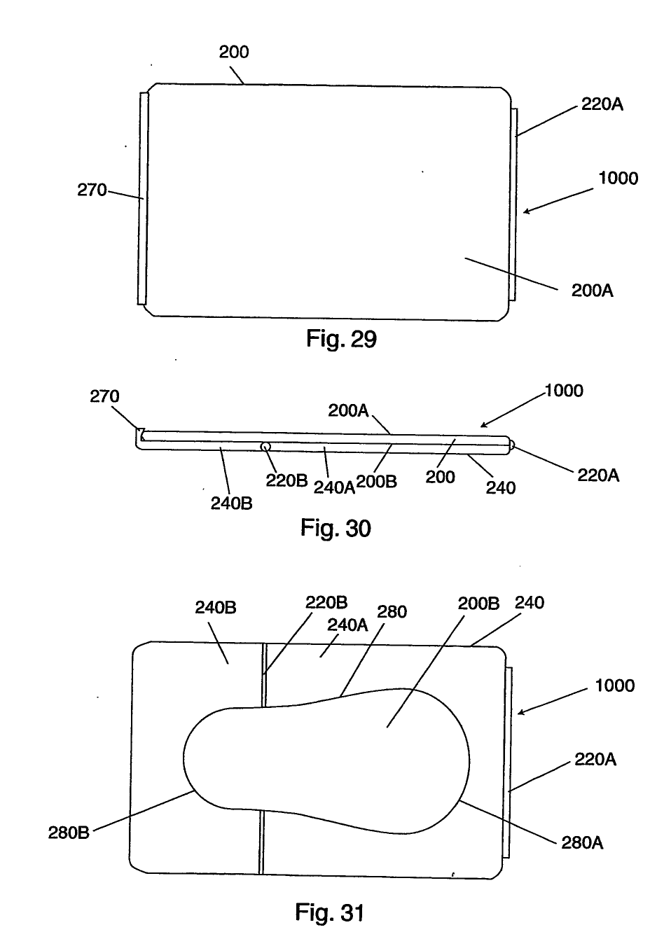

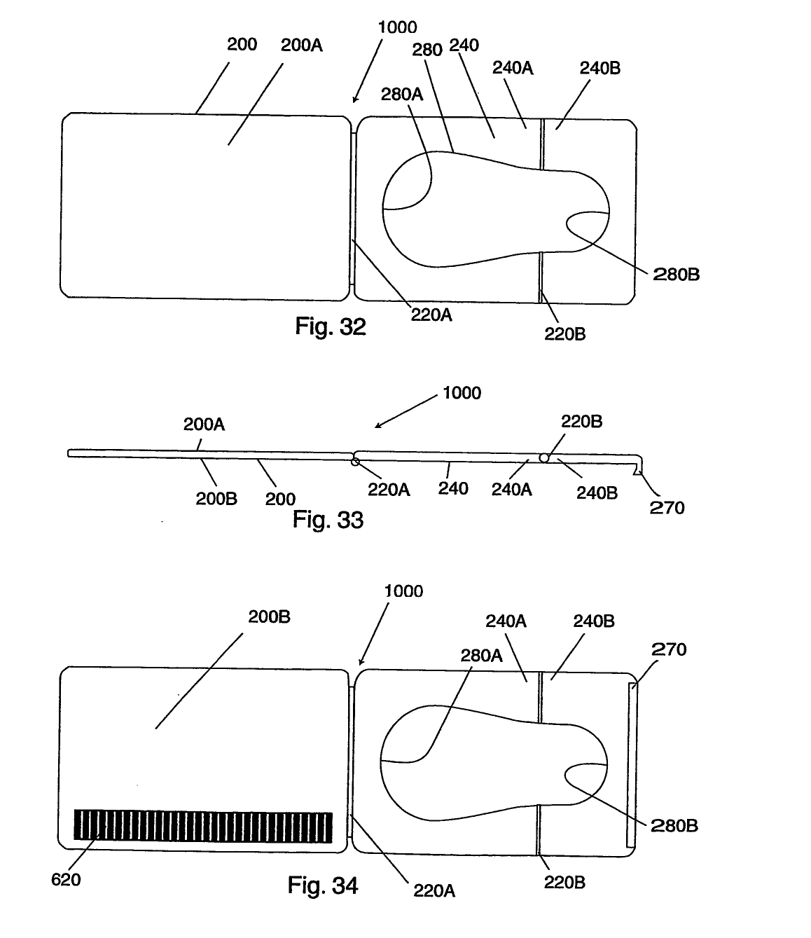

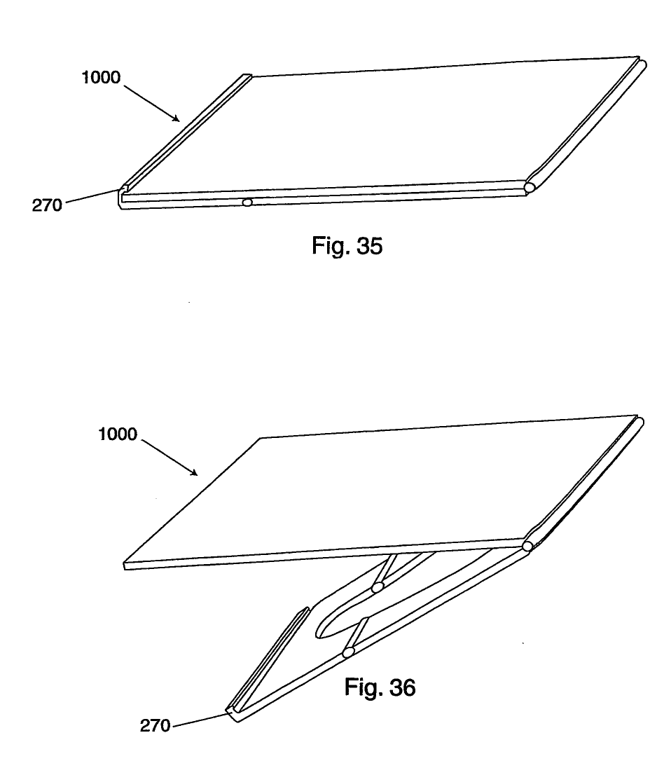

FIGS. 29 through 36 illustrate an alternate embodiment of universal card 1000 whereby latching display portion 200 to carrier portion 240 is accomplished by interference fit latch 270. Latch 270 is integral to carrier portion 240, which is unlike FIG. 5 of the preferred embodiment where the latch is integral to display portion 200. Keeping the display portion free of a latch or other protuberance allows it to be easily moved through the magnetic read heads of a magnetic strip card reader. FIG. 34 illustrates a typical edge placement of a magnetic strip or optical code strip 620. It should be noted that strip 620 could be placed anywhere on any portion of the 200 or 240, the driving factor being the magnetic or optical reader architecture. This embodiment is best suited to a banking card or hotel room key card where the display portion contains a magnetic strip that must fit into a card reader. By moving latch 320 from the display portion 200, as illustrated in the preferred embodiment, to the carrier portion 240 in this alternate embodiment, display portion 200 is free from obstructions that would hinder its being passed through the heads of a magnetic or optical reader.

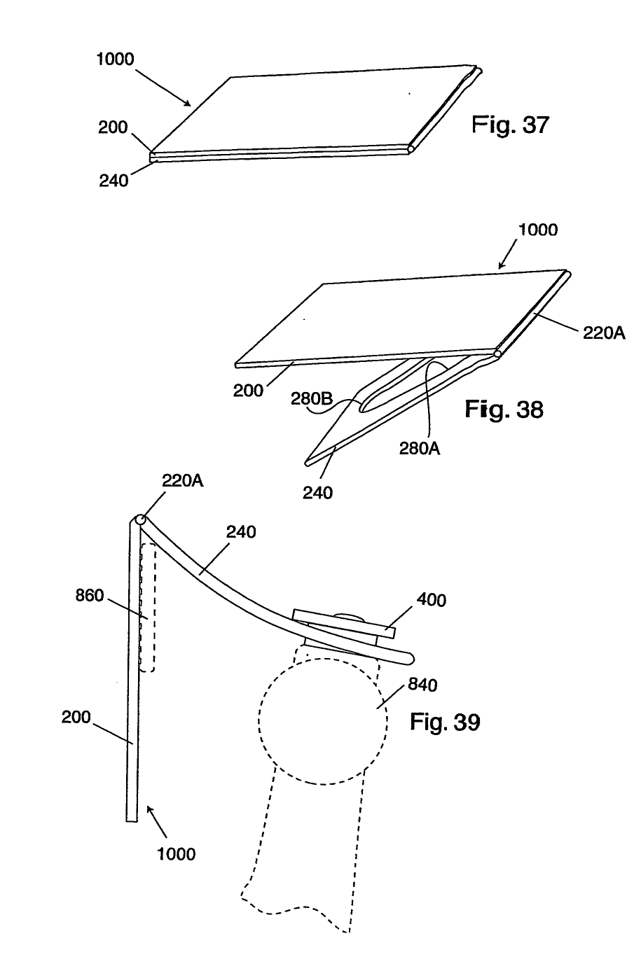

FIGS. 37 through 39 illustrate a simplified alternate embodiment of universal card 1000 without FIG. 5, hinge 220B and interference latch 320 and FIG. 33, interference latch 270. FIG. 37 illustrates 1000 closed for presentation as a business type card. FIG. 38 illustrates 1000 opened for use as a gadget carrier. FIG. 39 illustrates 1000 with display portion 200 tucked behind belt or strap 860 and gadget carrier portion 240 holding a gadget, hammer 840, fitted with adapter 400 to communicate with carrier portion 240. As in FIGS. 25 through 28, hammer 840 is installed and held captive by the slope created in carrier portion 240 when gravity pulls down on the mass of hammer 840.

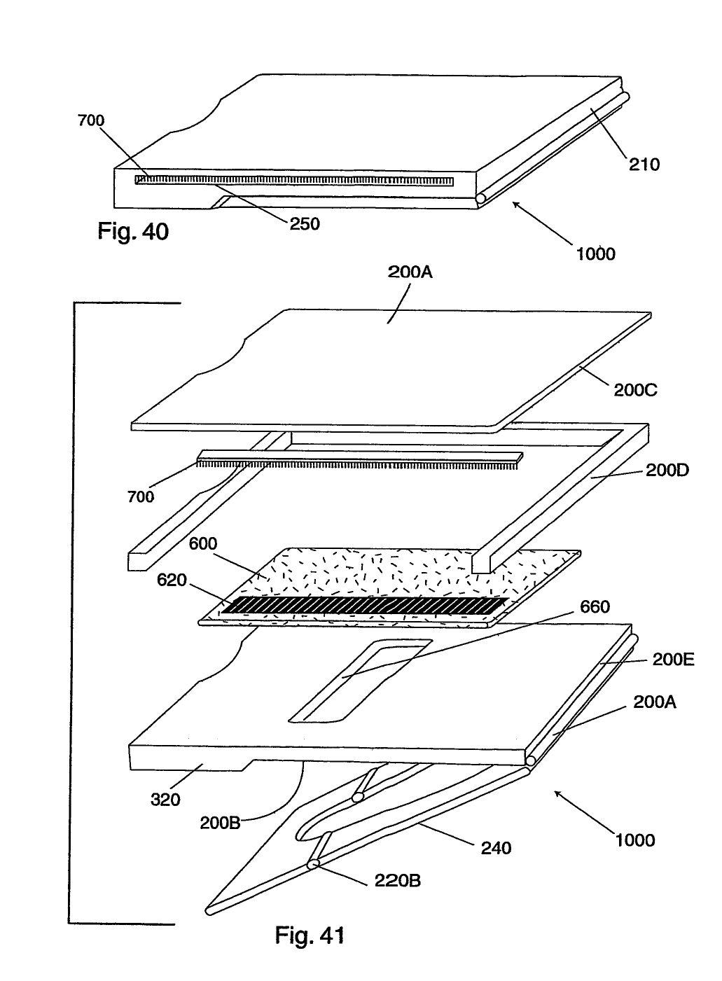

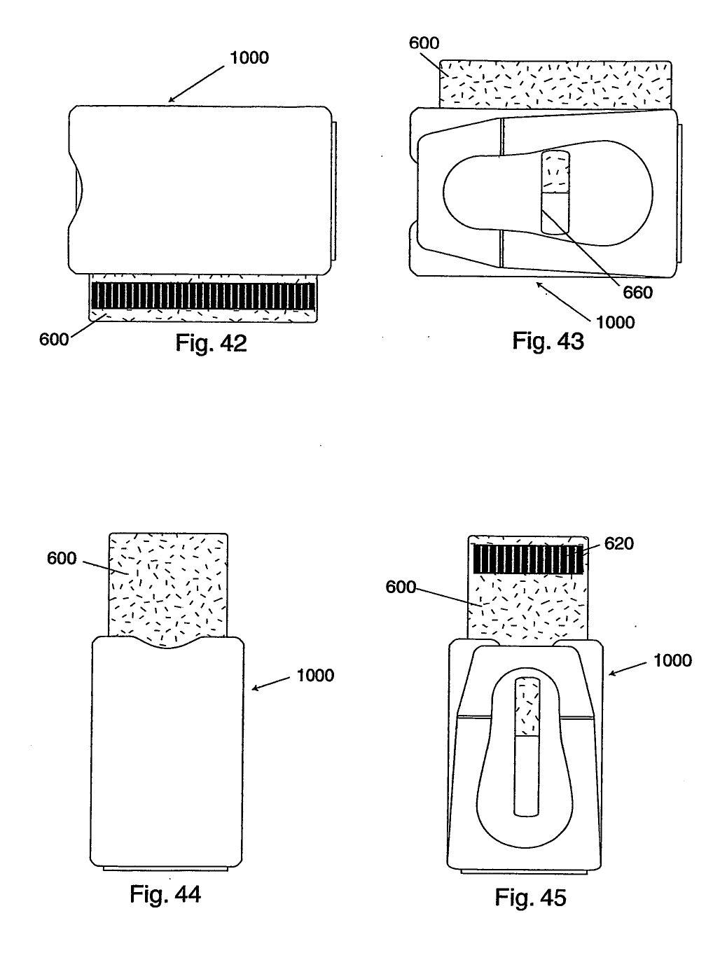

FIG. 40 illustrates an alternative embodiment of universal card 1000 employing an object holding section primarily designed to allow objects like credit cards to be held within and be easily accessible to be either completely or partially removable by the user. Slot 250 acts as an insertion path and removal path for internally carried card(s) or other objects, while brush block or friction block 700 serves to prevent the card(s) held within from falling out through the slot 250. Universal card 1000 in this embodiment serves to display information as well as carry cards within it that perform similar or other functions. FIG. 41 illustrates an exploded view of 1000. As in previous embodiments, 200A acts as the primary information and display surface. Slotted box 210 is comprised of top 200C, sidewalls 200D, and box bottom 200E. A card 600 with coded bar 620 is illustrated in the universal card's card carrying location. Finger access slot 660 illustrates one way that cards could be removed from box 210. Box 210 is hingedly attached to gadget carrier portion 240. Construction of such a box is common practice and well known to those skilled in the art of plastic injection molding and forming; therefore, a detailed description is not provided. FIG. 42 illustrates a top view of FIG. 40, universal card 1000 with card 600 partially protruding. FIG. 43 illustrates a bottom view of FIG. 42, illustrating finger access slot 660.

FIGS. 44 and 45 illustrate universal card 1000 with a box similar to 210 with an end slot alternative, more suitable for a hotel room key card. Universal carrier 1000 in FIGS. 44 and 45 is basically identical to 1000 in FIGS. 40 through 43 with the exception of the end card insertion and removal option rather than side card insertion and removal.

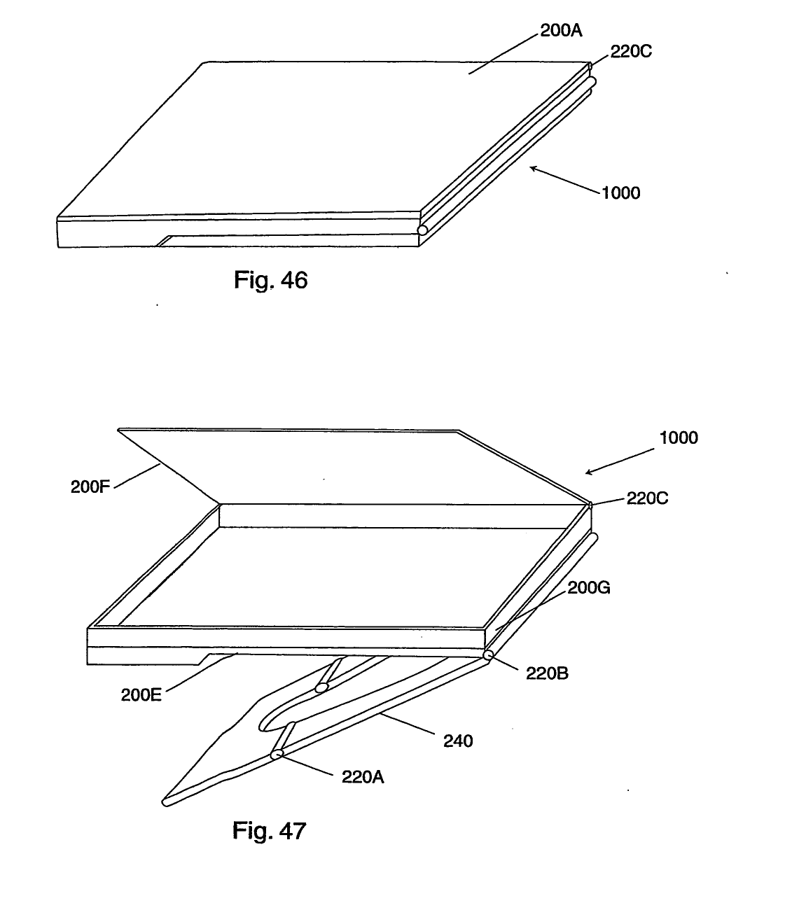

FIGS. 46 and 47 illustrate a card or object holding box holder similar to those disclosed in FIGS. 40 through 45 with the exception that 1000 in FIGS. 46 and 47 has a lid type box rather than a slotted box. Lid 200F retains primary display surface 200A and is opened and closed around third hinge 220C. Box lid 200F may or may not include a latching feature which could be similar to that illustrated in FIG. 33, latch 270.

Thus there has been described a universal carrier that is inexpensive and compact.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A universal carrying device, comprising:
a first substantially rectangular cover;
a substantially rectangular carrier having an opening wherein the substantially rectangular carrier has a hinge line; and
a hinge attaching the first substantially rectangular cover to the first substantially rectangular carrier.

2. The device of claim 1, wherein the hinge is a living hinge.

3. The device of claim 1, further including a carrier adapter that engages the opening.

4. The device of claim 1, wherein the hinge line extends across the opening.

5. The device of claim 3, wherein the opening has a narrow end and a fat end, the fat end is near the hinge.

6. The device of claim 1, wherein the first substantially rectangular cover snap fits with the substantially rectangular carrier.

7. The device of claim 1, further including a lip along a portion of the substantially rectangular cover.

8. A universal carrying device, comprising:
a first substantially planar cover;
a second substantially planar cover having an opening; and
a hinge attaching the first substantially planar cover and the second substantially planar cover wherein the first substantially planar cover snap fits with the second substantially planar cover.

9. The device of claim 8, wherein the second substantially planar cover has a hinge line.

10. The device of claim 8, wherein the first substantially planar cover has a lip.

11. The device of claim 8, further including a carrier adapter that engages the opening.

12. The device of claim 8, wherein the opening has a wide end and a narrow end.

13. The device of claim 10, wherein the first substantially planar cover has a flange along a portion of the lip.

14. The device of claim 8, wherein the hinge is a living hinge.

15. A universal carrying device, comprising:
a first substantially planar cover having a lip along a portion of a periphery of the first substantially planar cover;
a second substantially planar cover having an opening; and
a living hinge attaching the first substantially planar cover and the second substantially planar cover.

16. The device of claim 15, further including a second living hinge in the second substantially planar cover.

17. The device of claim 15, wherein the first substantially planar cover snap fits into the second substantially planar cover.

18. The device of claim 15, wherein the first substantially planar cover has a printing surface.

19. The device of claim 15, wherein the first substantially planar cover has a cut out.

20. The device of claim 15, further including a carrier adapter that engages the opening.
